(19) United States
(12) Patent Application Publication
(10) Pub. No.: US 2002/0166238 A1
(43) Pub. Date: Nov. 14, 2002

(54) Survival method and apparatus

(76) Inventor: Edward Kaufer, Reno, NV (US)

Correspondence Address: Herbert C. Schulze, PMB36, 2790 Wrondel Way, Reno, NV, 89502, US

(21) Appl. No.: 09/867,968

(22) Filed: May 29, 2001

Related U.S. Application Data
(63) Continuation-in-part of application No. 09/800,451, filed on Mar. 7, 2001.

(51) Int. Cl. B26B 13/22

(52) U.S. Cl. 30/125; 30/131

(57) ABSTRACT

This is a method and apparatus for survival purposes incorporating a method of forming substantially hexahedron shaped packages of tape which can be easily carried in clothing or the like and the incorporation with the tape, or supplying separately survival tools including scissor and knife and canister items with accompanying fire making facilities.

### CROSS REFERENCE TO RELATED PATENT APPLICATIONS

This application for patent is related to, and is a continuation in part of, my co-pending application for patent entitled “Pocket Tape Dispenser” Ser. No. 09/800,451, filed Mar. 7, 2001.

### BACKGROUND OF THE INVENTION

I. Field of the Invention

This invention is in the general field of protective methods and apparatus;

The invention is even more particularly in the general field of useful methods and apparatus for individuals of all levels of physical abilities to assist in overcoming difficult circumstances such as personal endangering situations, property protection, transport convenience and the like.

The invention is most particularly directed a particular product known as “Duct Tape”and a method and apparatus for enhancing its use. More correctly it is directed to all pressure sensitive tapes ( hereafter when I use the term “duct tape” or the term “pressure sensitive tape” it must be understood that both are included in each instance) and to certain survival items including the packaging of pressure sensitive tape making its use under difficult conditions more effective and convenient.

II. DESCRIPTION OF THE PRIOR ART

There have been many cutting devices and the like for cutting tape of various types. There is no need to recite these devices as all are well known.

Tape, and in particular Duct Tape is well known. Duct Tape has been used for many purposes other than its primary intended use in plumbing and the like. For example, outdoors enthusiasts, handy persons, and the like have used Duct Tape for many purposes such as to repair clothing, to reinforce tent seams, to bundle diverse items together for transport, and the like.

However, all such uses contemplate a supply of tape on a roll of some sort. In some cases, people have wound small amounts of Duct Tape from a large roll onto a pencil, or other small object, in order to create a quantity of tape in a more convenient carrying package.

Additionally, alternate methods of cutting tape, particularly tape which has already been removed from its storage unit are deemed desirable. In this connection, a convenient general purpose cutting instrument is desirable.

I have now improved upon my device described in my co-pending application for patent referred to above in order to include several new, unique, and useful methods and implements for outdoors persons and the like. My inventions now include means and methods for cutting and shaving incendiary materials, for starting fires, for visual examination of various things, and for general aid and assistance under adverse conditions.

I have searched in the literature, patent files, commercial sources, and the like. I have found no readily useable, durable, and inexpensive device or method for carrying duct tape in an easily packed configuration, with appropriate and easily accessible cutting arrangements. Additionally I have searched for any prior art concerning means and methods for cutting and shaving incendiary materials, for starting fires, for visual examination of various things, and for general aid and assistance under adverse conditions. I have found no prior art as to the items described in my afore referenced patent application. I have, however, found prior art which, at first glance, appears to be related to what I have conceived and developed relating to means and methods for cutting and shaving incendiary materials, for starting fires, for visual examination of various things, and for general aid and assistance under adverse conditions.

The prior art I have found which may appear to have some of the features of my invention include the following U.S. Pat. Nos.: 4,698,068; 4,882,841; 4,944,392; and 5,214,853. Examining those patents I have found that they cannot accomplish, and do not suggest nor anticipate the multitude of things which my invention accomplishes.

Thus, I have found nothing which I consider to be complete prior art as to my present invention as is described below.

### SUMMARY OF THE INVENTION

There are numerous situations in which individuals, regardless of their physical prowess, find themselves unable to cope with immediate and temporary emergencies. Such situations include those occasions when a person or an animal may become so unruly as to pose a grave danger to other persons, animals, or property. Such situations have made headlines recently where aircraft have been involved. Without explanation, individuals have become momentarily deranged and have endangered entire planeloads of passengers and cargo. One person under a momentary attack may be capable of holding a large number of others at bay. This can, and does, occur where animals need to be restrained. Also, emergency situations occur where it may be required to restrain cargo against violent movement which might threaten persons or other cargo.

Under emergency circumstances of the nature mentioned, and others, people frequently attempt to restrain objects, persons, and animals with rope, chains, and bare hands. Such attempts are frequently cumbersome and awkward, or may require such great strength and cooridination as to be ineffective.

Also, there are innumerable situations where persons are faced with a requirement for temporary repair, first aid, and the like. Such occurrences, and their solutions using Duct Tape or the like are particularly well known to outdoors persons. Duct Tape has been used for emergency splints, for tent and clothing repair, for shoes, and many other purposes.

In most of the situations mentioned above, and in many situations where binding, first aid, improvised repairs, and the like, are required, common Duct Tape can be used for temporary (and sometimes permanent) repair or improvisation. The use of Duct Tape is known to those skilled in various arts including, but not limited to, carpenters, plumbers, electricians, outdoors enthusiasts, and the like. Duct Tape is customarily available in large rolls. This particular characteristic of various ducts tapes and the like causes such tape to be less than fully effective for emergency uses due to the difficulty in carrying and applying tape from such large such large rolls, particularly under adverse conditions.

There are many emergency situations under which a person engaged in outdoors activities requires a fire. In many of such circumstances there may be unusual conditions which make it difficult or impossible to start a fire with customary matches, lighters, or the like. As examples, a person attempting to use the survival tape disclosed in my above referenced co-pending application for one of the purposes for which it is designed may fall into a lake, river, swamp or the like. Under this circumstance matches, lighters, and the like may be unusable, yet it may be vital that a fire be started. There are, also, cases where a magnified view of something is essential, such as a small sliver in a foot.

This invention is directed to making Duct Tape easily available and useable under a variety of circumstances, and it is directed to auxiliary means to cut and use the tape as well as universally adaptable means for visual magnification and for fire starting.

Although I have searched through literature, other publications, patents, and the like I have found no prior art as to a convenient way for the average person to carry and utilize Duct Tape for whatever circumstance may arise, or for the other situations mentioned.

I have now conceived and developed an apparatus and method for packaging, carrying, and using duct tape convenient and economical for all persons and situations. I have done this by constructing a device which carries a variety of cutting and application Duct Tape tools together with a manageable and convenient quantity of Duct Tape. Also, I have now combined some of these tools with adjuncts allowing for magnification and for starting fires. Very importantly, I have conceived and developed methods for reshaping conventional rolls of pressure sensitive tape into more convenient and effective form.

It is an object of this invention to provide a means for convenient carrying of a useable quantity of Duct Tape;

It is another object of this invention to provide such means in cooperative relationship with a means to cut convenient lengths of the Duct Tape;

Another object of this invention is to provide such a method for proper utilization of such Duct Tape under adverse conditions;

Another object of this invention is to provide a means for starting fires;

Another object of this invention is to provide a means for magnification;

Another object of this invention is to provide a method for reshaping conventional rolls of pressure sensitive tape into more convenient and more effect shapes.

The foregoing and other objects and advantages of this invention will become apparent to those skilled in the art upon reading the following description of preferred embodiments together with a review of the appended drawings.

### BRIEF DESCRIPTION OF THE DRAWINGS

FIG. 1 is a schematic perspective of an apparatus suitable to practice the methods of this invention;

FIG. 2 is an exploded view of the apparatus of FIG. 1;

FIG. 3 is a side elevation of an alternate embodiment of an apparatus suitable to practice the method of this invention with a quantity of Duct Tape mounted thereon; .

FIG. 4 is a schematic top elevation of the apparatus of FIG. 3, with elements in phantom;

FIG. 5 is schematic exploded view of the apparatus of FIGS. 3 and 4;

FIG. 6 is a schematic exploded view of an alternate form of scissors which can be utilized to practice certain methods of this invention;

FIG. 7A is a schematic perspective of the scissors of FIG. 6 being used to practice methods of this invention;

FIG. 7B is a schematic perspective of the scissors of FIG. 6 being used to practice methods of this invention;

FIG. 7C is a schematic perspective of the scissors of FIG. 6 being used to practice methods of this invention;

FIG. 8 is a schematic exploded view of a knife which can be utilized to practice certain methods of this invention;

FIG. 9A is a schematic perspective of the knife of FIG. 8 being used to practice methods of this invention;

FIG. 9B is a schematic perspective of the knife of FIG. 8 being used to practice methods of this invention;

FIG. 9C is a schematic perspective of the knife of FIG. 8 being used to practice methods of this invention;

FIG. 10 is a perspective of a fire making canister suitable to practice methods of this invention;

FIG. 10A is an exploded view of the apparatus of FIG. 10;

FIG. 11A is a schematic perspective of the canister of FIG. 10 being used to practice methods of this invention;

FIG. 11B is a schematic perspective of the canister of FIG. 10 being used to practice methods of this invention;

FIG. 11C is a schematic perspective of a portion of the canister of FIG. 10 being used to practice methods of this invention;

FIG. 12 is a schematic perspective of a customary roll of pressure sensitive tape about to be reshaped; and

FIG. 13 is a schematic perspective of the tape of FIG. 12 after being reshaped.

### DESCRIPTION OF A PREFERRED EMBODIMENT

An inventory of the items bearing reference numerals on the drawings is:

| Numeral | Identification of item |
|---|---|
| 10 | hollow polyhedron tape mandrel |
| 12 | slot through hollow polyhedron tape mandrel |
| 13 | blade |
| 14 | sharpened edge of blade |
| 15 | blade backing handle |
| 16 | serrated blade |
| 17 | serrated blade edge |
| 18 | serrated blade backing handle |
| 19 | hook on blade backing |
| 19a | hook on blade backing |
| 20 | tape wound around mandrel |
| 22 | lifted end of tape |
| 110 | hollow polyhedron tape mandrel |
| 112 | slot through hollow polyhedron mandrel |
| 113 | enlarged pivot position |
| 114 | pivot holes in mandrel |
| 115 | pivot pin |
| 117 | swivel flexible blade mounting |
| 118 | swivel flexible blade |
| 119 | swivel flexible blade in transport mode |
| 120 | tape wound on mandrel |
| 121 | edge of tape |
| 122 | serrated cutting edge |
| 123 | intermediate position of blade |
| 124 | shoulder |
| 140 | scissors |
| 200 | scissors |
| 210 | one scissor blade and handle |
| 210a | handle |
| 210b | blade |
| 212 | finger opening |
| 213 | spark |
| 214 | tinder storage compartment |
| 215 | tinder storage compartment cover |
| 216 | cover pin |
| 216a | pin hole |
| 217 | scissor blade connector |
| 218 | flint |
| 218a | flint holder |
| 219 | striker |
| 220 | one scissor blade and handle |
| 220a | handle |
| 220b | blade |
| 222 | finger hole |
| 223 | compartment in handle for magnifying glass |
| 224 | magnifying glass |
| 227 | scissor blade connector |
| 228 | magnesium |
| 228a | magnesium shavings |
| 230 | tinder |
| 231 | concentrated sunlight |
| 300 | knife |
| 301 | blade |
| 310 | handle center |
| 312 | handle mounting stud |
| 315 | magnifying glass |
| 316 | magnesium |
| 316a | magnesium shavings |
| 318 | shoulder |
| 319 | shoulder |
| 320 | handle carrying tinder and flint |
| 322 | socket for handle stud |
| 328 | flint |
| 330 | tinder |
| 331 | sunlight concentrated by magnifying glass |
| 340 | handle carrying magnesium and magnifying glass |
| 342 | socket for handle stud |
| 343 | opening in handle for carrying magnifying glass (not visible) |
| 400 | fire starting canister |
| 401 | tube |
| 402 | threads |
| 403 | threads |
| 403a | threads |
| 404 | matches |
| 407 | threaded end cap |
| 407a | lanyard eye |
| 410 | end cap with exterior serrations |
| 412 | flint |
| 413 | spark |
| 415 | magnesium |
| 420 | magnifying glass |
| 430 | tinder |
| 450 | lanyard |
| 500 | roll of pressure sensitive tape |
| 510 | tape |
| 512 | paper tube (core) |
| 515 | adhesive |
| 520 | pressure |
| 530 | pressure |

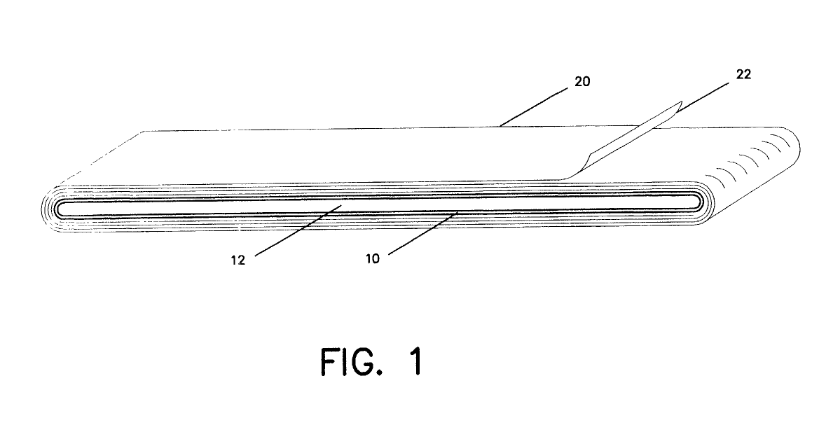

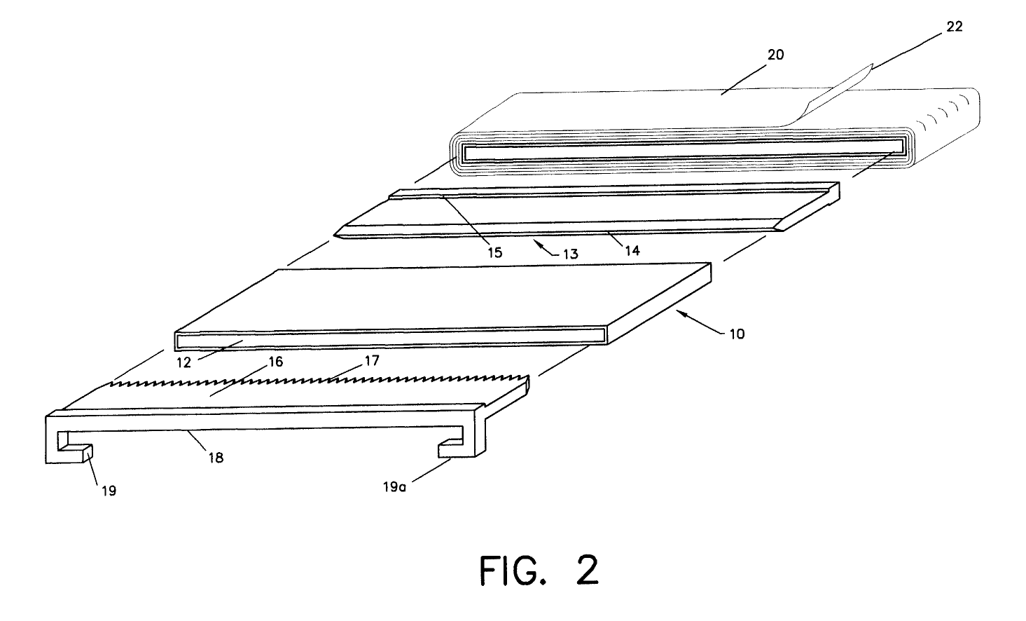

Referring to FIGS. 1 and 2 together, it will be noted that a hollow polyhedron mandrel 10 is the base for a length of duct tape 20 which is wound around the mandrel as shown. The mandrel in this case has a rectangular cross section. Those skilled in the art will realize that other configurations of mandrel might be used, but the most convenient and useful for the purposes for which this invention is made is as shown.

The mandrel 10 is hollow and carries within its hollow inner portion or slot 12 two knife-like instruments 13 and 16. The blade instrument 13 has a sharp knife edge 14 and an elongated enlarged handle 15 adapted to fit snugly within the slot 12. The knife edge 14 can be used to cut the tape or for any other knife and cutting purposes. The blade instrument 16 has a serrated edge 17 and enlarged elongate handle 18 suitable to fit properly within the slot 12.

The blade instrument handle 18 may be fitted with two hook-like projections 19 and 19a. The hook-like projections will be moveably mounted in a manner which will be apparent to those skilled in the art so that they may be hooked firmly into opposite ends of the slot in order to clamp the serrated blade flat onto the tape 20 to provide easily adaptable and controllable cutting of desired lengths of the tape. It will be understood by those skilled in the art that a similar arrangement can be made to work with the cutting blade 13.

FIG. 3 is a side elevation of an alternate embodiment of this invention. A polyhedron mandrel 110 with hollow interior 112 is shown with Duct Tape 120 wound about the mandrel. The edge of the tape 121 will be lifted when desired to peel off a length of tape for a desired purpose.

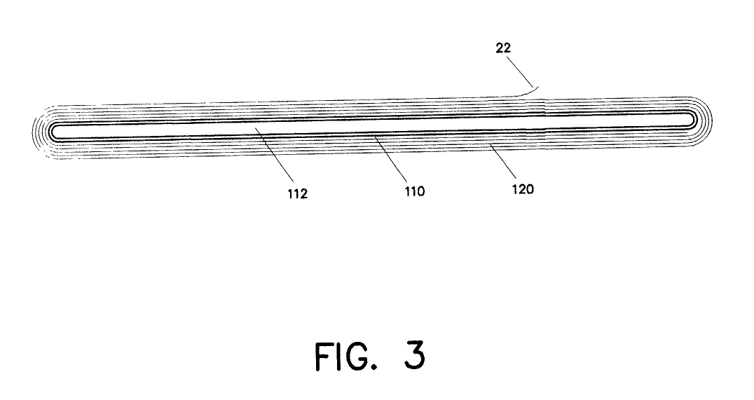

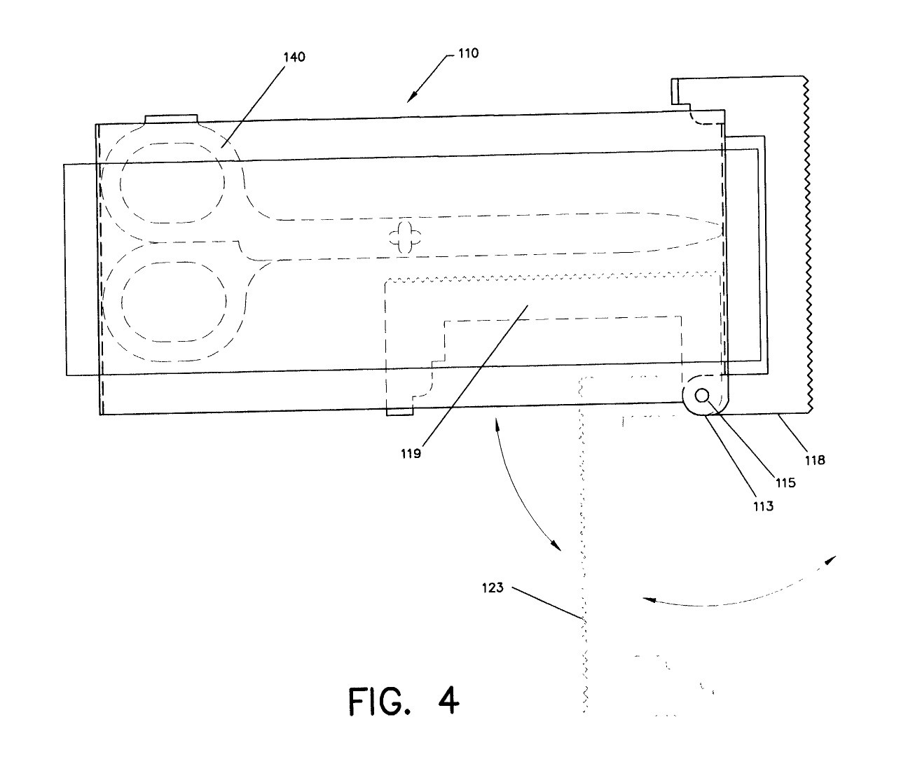

FIG. 4 is a schematic top elevation of the apparatus of FIG. 3. Various elements are shown in phantom for a clear understanding of the interaction and relationship of the elements. A swivel blade, or cutting member, 118, with serrated edge 122 is shown in position for use in cutting a length of tape. The two phantom positions of the swivel blade show how it is in transport mode 119, and intermediate 123. The unique shape of the blade 118 is important. The shoulder 124 rests against the mandrel 110 as indicated. This allows for clean cutting of the tape as will be understood by those skilled in the art. The scissors, 140 is provided for use in trimming tape, or for other purposes at a location distant from the mandrel and blade 118.

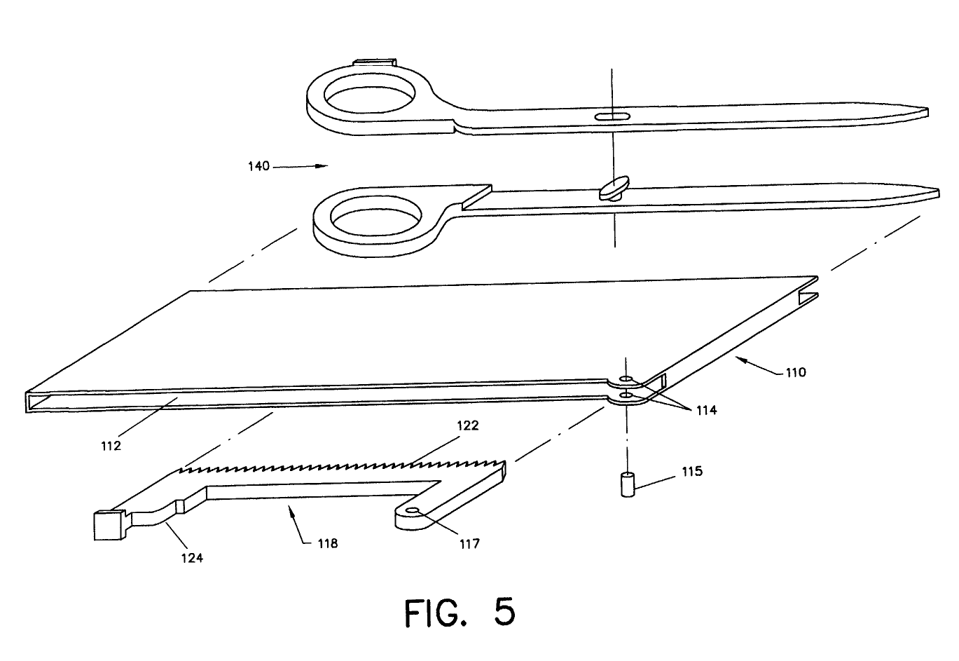

FIG. 5 is an exploded view of the mandrel, blade, and scissors combination. This will be understood by those skilled in the art.

It is generally preferred that this item and all of the components be made of plastic material. This is preferred because of weight, resistance to corrosion, and the like as will be understood by those skilled in the art. However, it is to be understood that the invention is not limited in that regard, since other materials, such as metals, and the like, now in use, or to become discovered in the future, may be deemed desirable by some users.

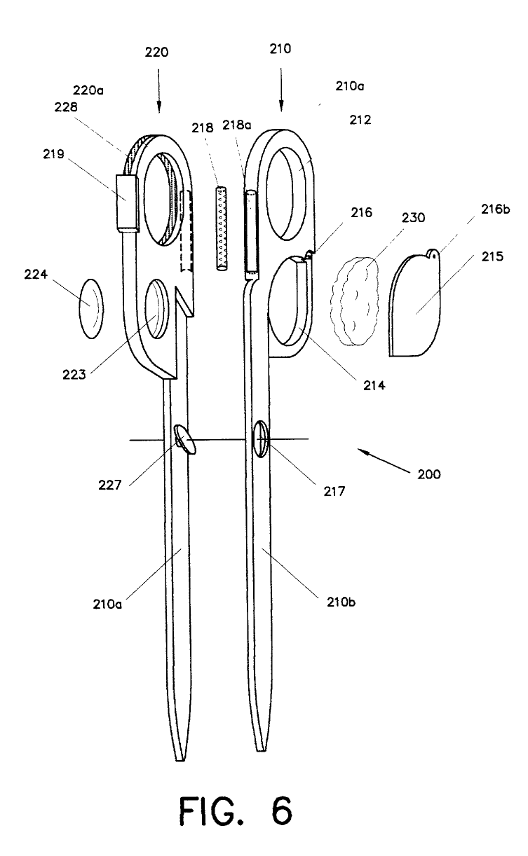

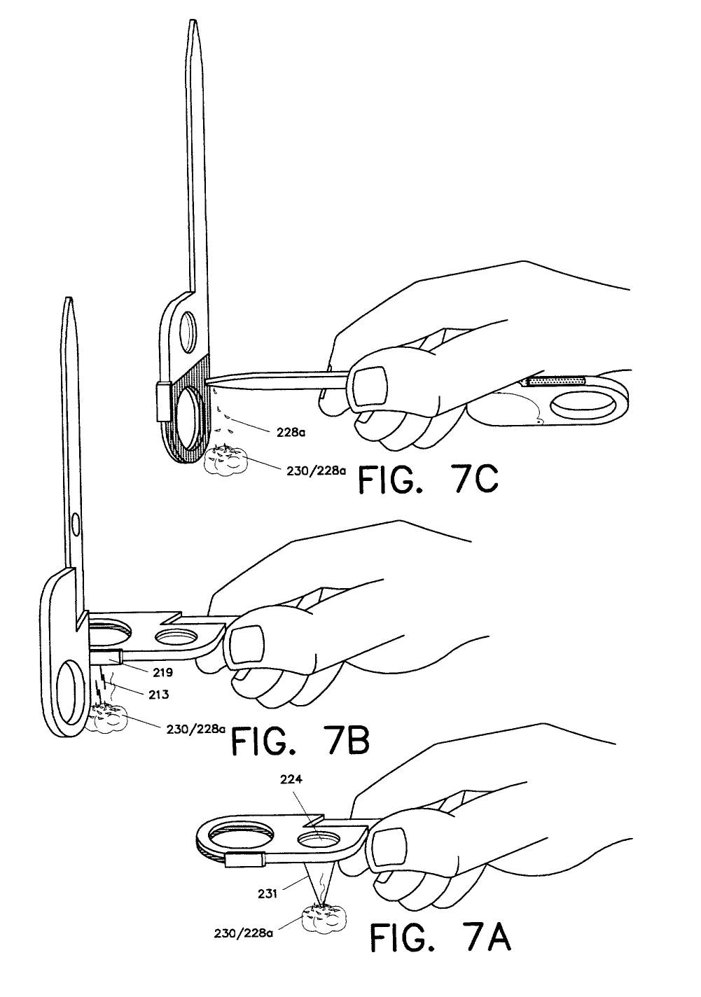

FIGS. 6, 7A, 7B and 7C show an alternate, and improved, scissors which can be carried in the hollow polyhedron tape core previously described and illustrated together with the unusual uses for which it is intended. The scissors is shown in an exploded view in FIG. 6 and in use in FIG. 7. The scissors consists of two blade and handle elements 210 and 220. The two elements are connectable by the interconnection of connectors 217 and 227. There can be a large number of different ways to accomplish this as will be understood by those skilled in the art. The handle and blade elements 210a/210b and 220a/220b are purposely made detachable for specific uses as herein described. Handle 210a has a finger opening 212 and a compartment 214 which is used for storage of tinder 230. The tinder may be any relatively easily ignited material such as cotton or the like. A cover 215 is pivotally connected to the handle by pin 216 through pin hole 216a as will be known to those skilled in the art. If desired, there may be a gasket on the cover to ensure that the tinder 230 will stay dry when in the compartment.

A flint 218 is adhered to the handle 210a by adhesive or other means known to those skilled in the art. The flint 218 may actually be flint stone, or any substitute which will yield sparks 213 when appropriately struck by an appropriate striker 219 shown in FIG. 7B and as is known to those skilled in the art. Handle 220a will carry a ring of magnesium 228 or other material such as balsa wood or the like which can be shredded into a highly combustible bits of material 228a by blade 210b as shown in FIG. 7C. The highly combustible material 228a is collected on the tinder 230 making it an excellent fire starting combination. Alternatively the tinder and shredded combustible material 230/228 a may be ignited by concentrating the rays of sunlight through magnifying glass 224 in handle 220a and as shown in FIG. 7A.

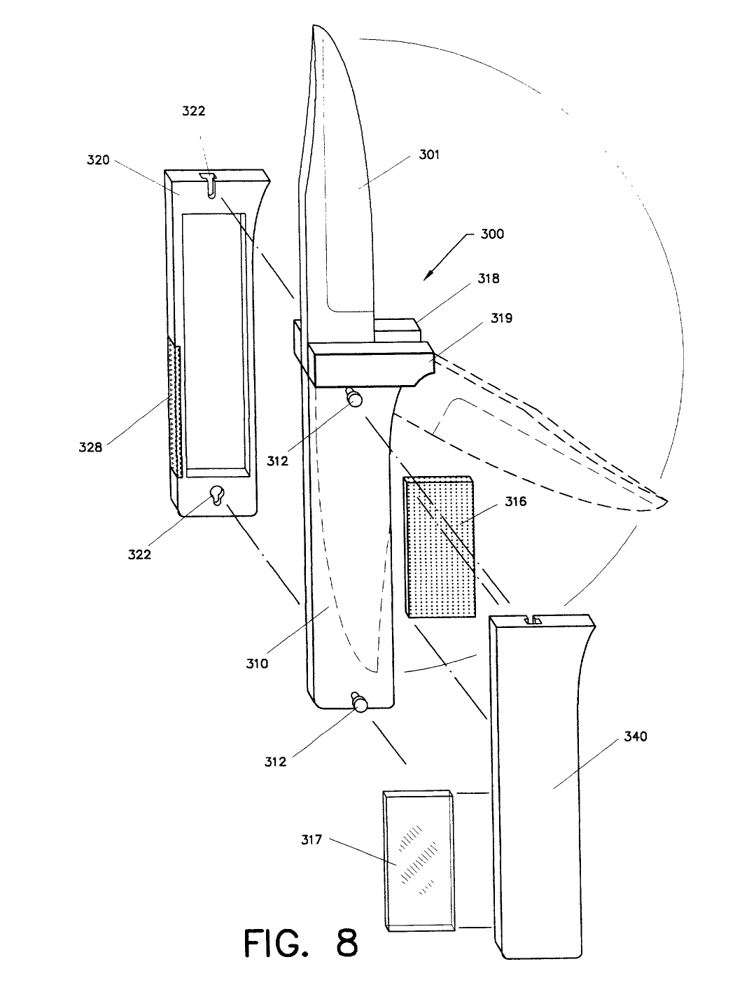

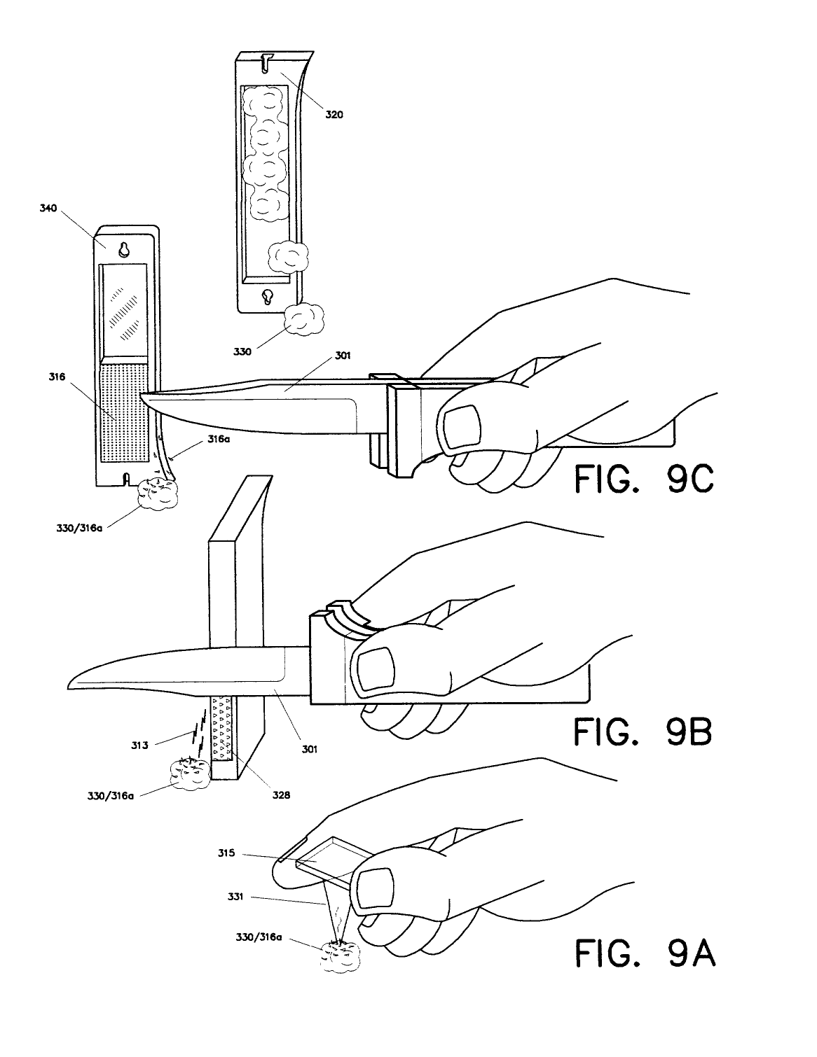

FIGS. 8, 9A, 9B and 9C illustrate a knife which I have now developed which may be carried in the polyhedron tape core previously described, or independent thereof The knife 300 is shown exploded in FIG. 8 and being used to start fires in FIGS. 9A, 9B, and 9c. The knife handle is formed in three segments. The center portion 310 of the handle has a slot to receive the blade 301 when not in use. The slot is not shown, nor is the knife blade hinge, but these are well known to those skilled in the art. Exterior handle portions 320 and 340 are essentially mirror images of one another. Handle 320 has a compartment carrying tinder 330. Handle 340 has a compartment carrying magnesium 316 and magnifying glass 317. Handle portions 320 and 340 mount under shoulders 318 and 319. Handle portion 320 snaps into place on handle portion 310 by engaging its two sockets 322 on two studs, not visible on FIG. 8, but identical mirror images of studs 312 which will be understood by those skilled in the art. Handle portion 340 snaps into position in a similar manner utilizing two studs 312 and two sockets 342, only one of which is visible on FIG. 8. In use for making a fire the magnifying glass 315 is removed from its compartment and used to concentrate sunlight 331 to ignite tinder/shavings consisting of cotton or the like 330 and shavings of magnesium or the like 316a. Alternatively, fire may be started by shaving magnesium or the like 316a with knife blade 301 from the block of magnesium or the like 316 onto cotton tinder or the like 330 as shown in FIG. 9c and then creating sparks 313 onto the tinder/magnesium 330/316a by striking flint 328 with knife blade 301 as shown in FIG. 9B.

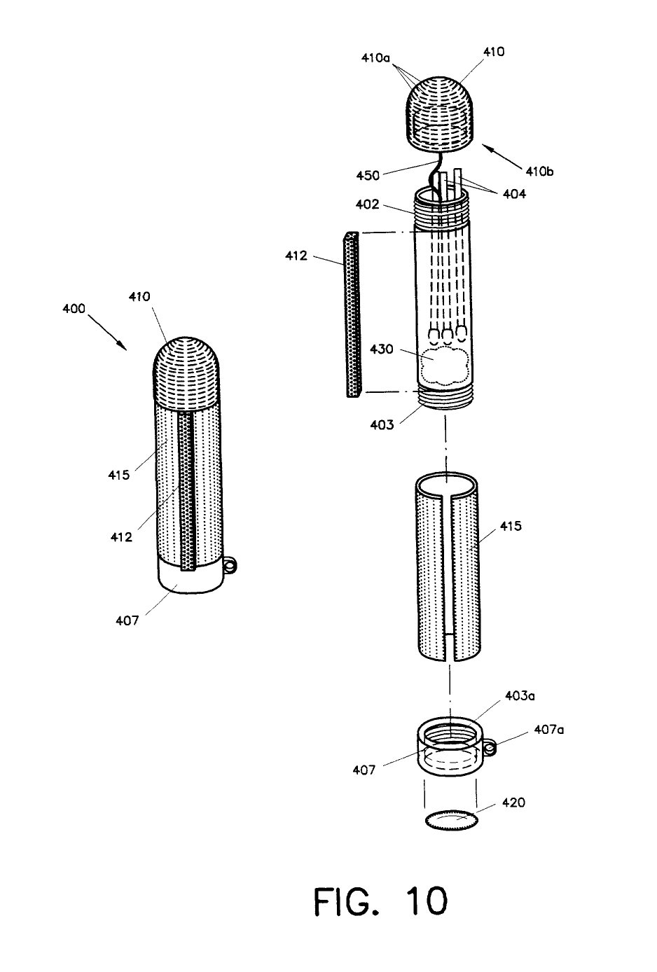

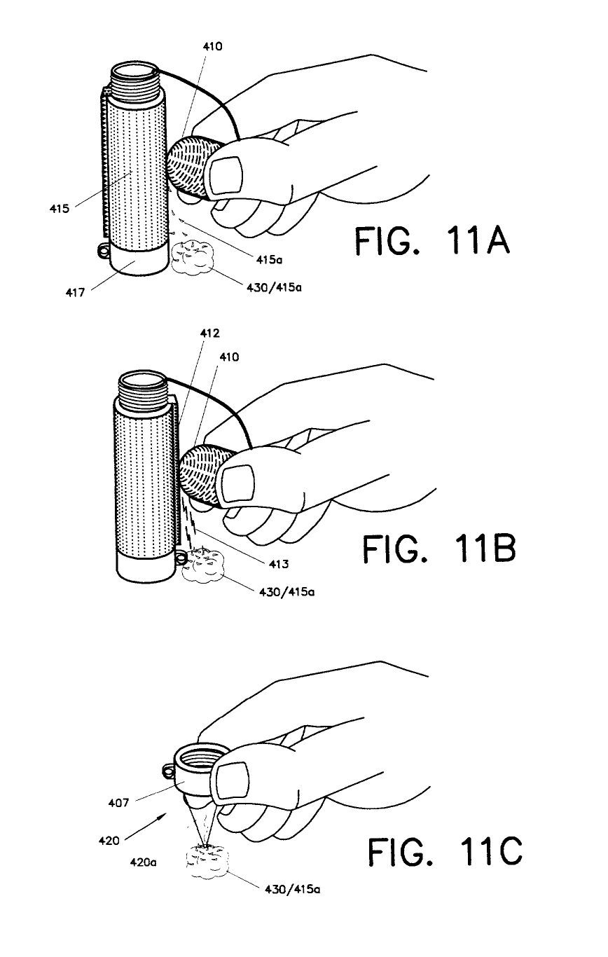

Another alternate fire making device which may be inserted into the polyhedron core of a roll of tape is shown in FIGS. 10A, 10B, 11A, 11B and 11C. In this case a canister 400 is shown to be comprised of tubular member 401 having threads 402 and 403 on its ends. A partial cylinder 415 of magnesium or the like is mounted on tubular member 401 along with flint 412. Matches 404 and tinder 430 are carried in the tubular member. End cap 407 is a short internally threaded 403 tube with a lanyard eye 407a and magnifying glass 420 mounted as shown. Dome shaped cap 410 is internally threaded 410b and has a rasp like outer surface 410a. In use for making fires, the tube may be opened and the rasp like surface 410a may be used to scrape shavings 415a from magnesium or the like 415 onto tinder 430 as shown in FIG. 11A. Matches 404 may be used to ignite the tinder/magnesium or the like 430/415a, or sparks 413 may be created by striking the flint 412 with cap 410 to ignite the tinder/magnesium as shown in FIG. 11B, or magnifying glass 420 in end cap 407 may be used to concentrate sunlight 420a in order to ignite the tinder/magnesium 430/415a. I have provided a lanyard 450 as shown to secure the cap in case it is dropped when in use.

I have now conceived and developed a very significant advance in the pressure sensitive tape field. In working to perfect my original invention as shown in FIGS. 1 through 5 I have found that I can reshape a customary cylindrical roll of tape into an essentially hexahedron package of tape with a device such as is shown in FIGS. 1 through 5 within the reshaped hexahedron. However, it goes even further in that I can also reshape a customary roll of tape into what I refer to as a “flat-pack” of tape. The flat pack of tape is very advantageous for many tape uses and results in great savings and advantages in transportation and storage of tape. The full roll of tape when in the flat pack package can easily slip into a normal trouser or coat pocket. Additionally, the shipping and storage space required is greatly reduced. Another advantage of the flat pack is that when working on an inclined or uneven surface the tape does not roll away.

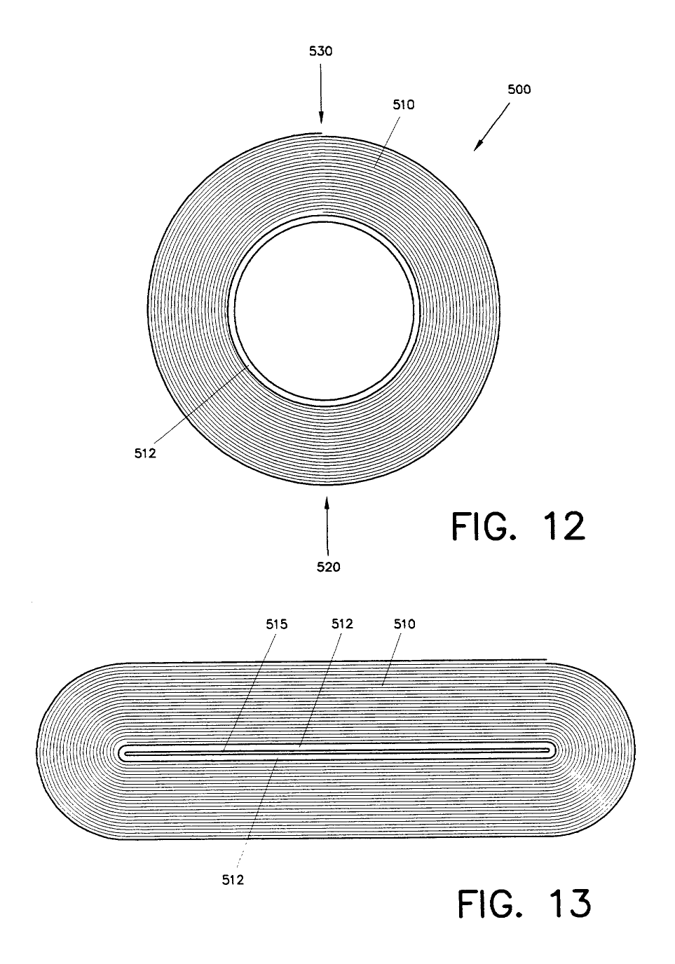

I have discovered that I can quickly and economically convert a roll of tape to a flat pack. FIGS. 12 and 13 are schematic representations which will be understood by those skilled in the art. FIG. 12 shows a customary roll 500 of pressure sensitive tape as presently manufactured and used. The roll comprises a paper or the like core 512 surrounded by a multiplicity of layers of tape 510. I have added to this two arrows 520 and 530. The two arrows 520 and 530 indicate a simple press. Such a device as a large vice could do this. By closing the vice or other press until there is no hollow space at all in the core I can form a completely reshaped flat pack package of tape. By putting adhesive on the inside of the paper or other core before compressing it, the flat pack of tape will remain flat and stable until all of the tape has been used.

I have also found that I can compress the roll in this fashion and instead of flattening it completely, I can flatten it partially to achieve a shape approximately as shown in FIG. 1, with the hollow polyhedron mandrel being the reshaped paper or the like core 512. I can then insert one of my devices such as is shown in FIGS. 4 and 5. In this manner I can make the devices of FIGS. 1 through 5 without the necessity of a separate hollow polyhedron tape mandrel.

As a last method supplying pressure sensitive tape in a flat pack, I can wind the tape around a flat polyhedron. A piece of cardboard or the like with tape wound around it could acheive the same result as shown in FIG. 13.

In the claims which follow, if I should fail to claim a patentable feature of this invention, such failure to claim will be due to inadvertence and not due to any intent to abandon, or dedicate such feature. In the event I learn of any such patentable feature which I have not claimed, I shall immediately seek to claim such feature by re-issue or other appropriate action.

While the embodiments of this invention shown and described are fully capable of achieving the objects and advantages desired, it is to be understood that such embodiments have been shown for purposes of illustration and not for purposes of limitation.

I claim:

1. A method for forming a substantially hexahedron shaped package of pressure sensitive tape comprising: forming a hollow tubular core; winding a multiplicity of layers of pressure sensitive tape around the tubular core to form a roll of pressure sensitive tape; and pressing the exterior of the roll of pressure sensitive tape in such manner that the hollow tubular core becomes substantially rectangular in cross section.

2. The method of claim 1 wherein the interior surface of the hollow tubular core is coated with adhesive, the pressing of the exterior of the roll of pressure sensitive tape continues until the hollow tubular core becomes flat, and pressing is maintained on the exterior of the pressure sensitive tape until the adhesive on the interior of the flattened hollow has set.

3. A survival scissors comprising: a first scissor blade and handle member wherein the handle carries a magnifying glass, a combustible material capable of being shaved by a scissor blade, and a striker; a second blade and handle member wherein the handle carries a compartment for storage of tinder and a flint; and detachable means connecting said first and second blade and handle members.

4. A survival knife comprising: a first handle member; a second handle member incorporating a tinder storage compartment and a flint detachably connected to said first handle member; and a third handle member containing a magnifying glass and a combustible material cable of being shaved by said knife blade detachably connected to said first handle member.

5. A survival canister comprising: a hollow tubular member having a first open end and a second open end; a combustible material mounted upon a portion of the exterior of the tubular member; a flint mounted on the exterior of the tubular member; matches and tinder contained in the tubular member; a cap incorporating a magnifying glass closing said first open end; and a cap incorporating a rasp-like outer surface closing said second end.

6. A method for preparing pressure sensitive tape for use comprising wrapping a multiplicity of layers of tape upon a flat hexahedron.
